(19) United States
(12) Patent Application Publication
(10) Pub. No.: US 2012/0118762 A1
(43) Pub. Date: May 17, 2012

(54) SENSING DEVICE AND METHOD

(75) Inventor: Eric Bakker, Bentley (AU)

(73) Assignee: Curtin University of Technology, Bently (AU)

(21) Appl. No.: 13/201,158

(22) PCT Filed: Feb. 12, 2010
(86) PCT No.: PCT/AU2010/000156

§ 371 Date: Dec. 13, 2011

(30) Foreign Application Priority Data
Feb. 13, 2009 (AU) 2009900623

(51) Int. Cl. G01N 27/333

(52) U.S. Cl. 205/789; 204/416; 204/415; 204/412

(57) ABSTRACT

A sensing device for the determination of ions in a thin layer sample (32) comprising: a first (12) and second (14) ion selective electrode, each having a first (16) and second layer (20); the first layer (16) of the first ion selective electrode (12) being a polymeric membrane layer in electrical contact with the second layer (20) of the first ion selective electrode (12), and the first layer (18) of the second ion selective electrode (14) being a polymeric membrane layer in electrical contact with the second layer (20) of the second ion selective electrode (14); the first and second ion selective electrodes being positioned in opposing arrangement such that, the respective polymeric membrane layers are in direct contact with a thin layer sample (32) containing ions, located between the first and second electrodes; and a detector (28) in electrical connection with the first (12) and second (14) ion selective electrodes.

### FIELD OF THE INVENTION

The present invention relates to a sensing device and method for the determination of analyte in a sample. In particular, the device and method of the present invention relate to the extraction of analyte ions from a thin layer sample to a selective membrane by electrochemical means to determine the concentration of the analyte.

### BACKGROUND ART

Analytical sensors, in particular potentiometric sensors, for determining analyte concentrations in various sample solutions have been an area of focus for some time, especially in the medical field where it is desirable to minimise as much as possible the sample size required to conduct a measurement.

One significant problem with the method of direct potentiometry with such sensors is their need for frequent recalibration to compensate for potential drift. Furthermore, potentiometric systems typically involve reference electrodes, which in turn require a liquid junction for accurate measurement. While potentiometric sensors are today widespread in clinical analysis settings, there is still a great need for robust sensor principles that do not require recalibration. Direct potentiometry as a method cannot meet this need.

In controlled potential coulometry, a potential is applied between two electrodes, which results in the exhaustive depletion of the analyte from a sample via a redox reaction. The process is monitored as a current, which depletes to zero as the reaction comes to completion. The current is integrated over time, yielding the coulomb number for the exhaustive process, which is then converted to the molar amount of material by Faraday's law. Controlled potential coulometry uses traditional metallic electrodes where oxidation and reduction reactions occur, but has found limited use in practice for two reasons: (i) it is difficult or impossible to impart sufficient chemical selectivity to the oxidation/reduction process for the principle to be useful for the analysis in complex sample compositions; and (ii) a close spacing of the two electrodes that make up the electrochemical cell is necessary to allow for a short analysis time. Furthermore, analyte species that are converted at one electrode can freely diffuse to the counter electrode to be converted to the original analyte, hence resulting in an undesired self-catalytic background current.

Thin-layer devices for determining analyte concentrations under controlled potential conditions are desirable because they have the potential to significantly reduce the sample size required, improve measurement times, and eliminate the requirement for repetitive re-calibration. However, as a result of the problems outlined above, few devices have been developed for thin layer analysis. One existing thin layer device has been developed in the field of glucose biosensors, in which an enzyme layer is attached to a conducting material at one of the electrodes. The approach still measures an oxidation/reduction reaction under a controlled potential, but couples the process to an enzymatic conversion step. The selectivity of the sensor is chiefly provided by the enzyme reaction. However, enzymes suffer thermal long term stability problems, as enzymes have a tendency to denature.

Another reported approach uses controlled potential to drive analyte ions from an aqueous sample solution placed in a porous tube material into a contacting organic solvent that contains a suitable ionophore for that ion. The electrochemical circuit is completed by placing a chlorinated silver wire within the tube and in close contact with the sample solution. Analyte cations present in the sample are extracted into the organic liquid phase, resulting in the oxidation of the silver metal to silver chloride placed on the silver wire, hence removing chloride counter ions from the sample solution to maintain charge neutrality. The current relating to this reaction is monitored and integrated over the analysis time. However, this approach is not practical for a variety of reasons. The simple organic solvents used to extract the analyte are a health and environmental hazard and make it impossible to miniaturize the device. The required contact length between the two solutions is in the order of 20 to 50 cm, relying on a coiled tube and large volumes of organic solvents. The large volume of organic solvent also makes it impossible for the device to be chemically regenerated, resulting in eventual contamination of the organic solvent and complete oxidation of the chlorinated silver wire. Moreover, the choice of chlorinated silver wire as counterelectrode in direct contact with the sample solution is inadequate for any samples that contain compounds that may form silver precipitates. Sulfide containing compounds, including amino acids present in most biological and environmental samples, will result in the fouling of the counter electrode and hence to erroneously applied potentials. This method would not be suitable for miniaturization to produce a device that would be portable or used by the average consumer, for example, medical patients.

It is an objective of this invention to provide a sensing device and method for controlled potential determination of an analyte, which at least partially overcomes one or more of the problems associated with the prior art.

The preceding discussion of the background art is intended to facilitate an understanding of the present invention only. The discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a sensing device for the determination of ions in a thin layer sample comprising:
a first and second ion selective electrode, each having a first and second layer;
the first layer of the first ion selective electrode being a polymeric membrane layer in electrical contact with the second layer of the first ion selective electrode, and the first layer of the second ion selective electrode being a polymeric membrane layer in electrical contact with the second layer of the second ion selective electrode;
the first and second ion selective electrodes being positioned in opposing arrangement such that, the respective polymeric membrane layers are in direct contact with a thin layer sample containing ions, located between the first and second electrodes; and
a detector in electrical connection with the first and second electrodes,

Preferably, the thin layer sample is not in direct contact with the second layer. The present invention confers the advantage that direct contact of the thin layer sample with the second layer is substantially eliminated in each electrode. For example ions are extracted from the thin layer sample under controlled potential conditions, into the polymeric membrane layer where they are electrically coupled to an electron transfer reaction at the second layer. The progress of the electron transfer reaction is detected by the detector. Thus, interferences of other ions in the thin layer sample are substantially minimised as there is no direct contact of the thin layer sample with the second layer. The polymeric membrane layer is itself selective to the analyte ion and therefore does not require an enzyme reaction to impart selectivity to the electrode.

The polymeric membrane layer is preferably in direct contact with both the thin layer sample and the second layer.

In one form of the invention the second layer may be formed of an aqueous or gelified inner solution in contact with a reference electrode to complete an electrochemical cell. Preferably, the second layer comprises a silver/silver chloride couple.

Alternatively, in another form of the invention the second layer may be formed of a solid transducer layer and a solid conducting layer. The combination of a solid transducer layer and conducting layer enables an electrical change to be monitored whilst substantially eliminating the requirement for inner aqueous electrolytes required for more traditional electrode designs.

In use, the transducer layer facilitates the conversion of an ion flux generated by an oxidation/reduction, into an electrical current so that it can be measured. Preferably the tranducer layer is formed from materials containing chemically bound functionalities that can be suitably oxidised and reduced while exhibiting hydrophobic characteristics, including but not limited to, ferrocene derivatives, and conducting polymers, including poly(aniline), poly(pyrrole), poly(alkyl thiophene) with alkyl chains that are between 2 and 12 carbons long, and poly(alkyldioxythiophene) and poly(alkylmonoxythiophene) with alkyl chains lengths of 2 and 12 carbons.

More preferably, the transducer layer is doped with an ionic species common to the polymeric membrane layer, for example a tetraphenylborate derivative.

Both the polymeric membrane layer and the transducer layer preferably exhibit electrochemical reversibility.

The transducer layer preferably also exhibits a suitable potential window, such that it helps avoid unwanted oxidation/reduction reactions with species other than the transducing material. More preferably, the potential window for oxidation is given above about 0.5V (measured against Ag/AgCl).

Preferably, there is also solvent compatibility between the tranducer layer and polymeric membrane layer.

The conducting layer preferably comprises any conducting material, including a conducting polymer, gold, gold coated copper, or a conducting carbon material.

In a first mode of operation the polymeric membrane layer preferably has limited ion-exchange properties to reduce the spontaneous extraction of any ions to and from the membrane and thin layer sample. This also helps to minimise spontaneous contamination of the thin layer sample via the contacting membrane. In this mode the membrane preferably contains a suitable lipophilic electrolyte, including, but not limited to, salts of long chain quaternary ammonium ions and tetraphenylborate derivatives or sulfonated organic ions.

Alternatively, as a second mode of operation, the polymeric membrane layer may comprise ion-exchange properties. Whilst operation in this mode may allow spontaneous extraction of ions to and from the thin layer sample, it has the benefit of allowing the use of thinner membranes or membranes that are fast diffusing.

Preferably, the polymeric membrane layer is also doped with ionophores, which contain suitable functional groups including, but not limited to, ether, polyether, thioether, ester, thioester, hydroxyl, amide, amine, thioamide, and metal coordinating functionalities for complexing ionic species. The ionophores may contain a lipophilic backbone to retain the molecule in the polymeric membrane layer. Alternatively, the ionophore may be covalently attached onto the polymeric backbone of the polymeric membrane layer, or onto a solid support layer.

The solid support layer is preferably formed from materials known in the art including but not limited to, silica, metal alloy or oxide such as porous alumina, ceramic, glass or glass fiber materials including filters, carbon, titania, carbide, nitride or sintered metal. Preferably, the polymeric membrane layer doped with ionophores has a mobility within the range of about 10⁻⁶ to 10⁻⁸ cm²s⁻¹. More preferably, the polymeric membrane layer doped with ionophores has a mobility within the range of about 10⁻⁶ to 10⁻⁷ cm²s⁻¹.

The polymeric membrane layer is preferably hydrophobic and water immiscible. This substantially avoids spontaneous uptake of electrolyte/thin layer sample solution, which would result in interference at the electrode and a difficulty in measuring the analyte ion. Preferred materials include polymers that are either plasticised or non-plasticised, including poly(vinyl chloride), poly(alkyl acrylate) with an alkyl chain length of 3 to 16, poly(alkyl methacrylate) with an alkyl chain length of 3 to 16, silicone rubbers, polyurethanes, or a combination or co-polymer thereof.

More preferably, the polymeric membrane layer is coated with a hydrophilic layer. The hydrophilic layer aids biocompatibility and confers a charge transfer resistance to regulate the ion transfer kinetics from the thin layer sample to the membrane phase. Such hydrophilic layers may include, but are not limited to cellulose materials, hydrogels, surfactants, covalently attached molecules containing hydrophilic or electrically charged functional groups, and polyelectrolyte multilayers.

The polymeric membrane layer may be in the form of a thin-layer membrane, with dimensions between about 10 nm to 10 μm, in order to facilitate the rapid and reversible ionic extraction in and out of the polymeric membrane layer.

Alternatively, in use, the polymeric membrane layer may be in the form of a thicker membrane layer, with dimensions between 10 μm to 10 mm, in order to act as a large electrolyte reservoir and to operate in a detection mode where regeneration of the polymeric membrane at the thin layer sample side is not critical. Further, this configuration preferably involves the selective ionophores being retained by second layer, such as by covalent attachment, and the remainder of the polymeric membrane layer acting as an electrolyte reservoir. More preferably, the second layer in this configuration is in the form of a thin layer with a thickness within the range of about 100 nm to 10 μm.

The distance between the polymeric membrane layers of the first and second ion selective electrodes is preferably in the range of 10 to 200 μm. This distance determines the thickness of the thin layer sample and thus enables the volume of the thin layer sample to be known.

The detector may be an electrical detector for coulometric determination, monitoring the total change in current as ions that are extracted into the polymeric membrane layer. Coulometry measures all of the analyte in a thin layer sample and therefore does not require calibration. Conversely, potentiometric measurements do require frequent calibration. Thus, despite developments which have enabled minimisation of electrodes for potentiometric measurements, the need for calibration is an undesirable aspect of all potentiometric devices which have been developed.

Alternatively, the detector may be an optical detector. The optical detector detects a change in colour in the polymeric membrane layer. The change in colour may result from a reaction of the analyte ion with an ionophore in the polymeric membrane layer. The polymeric membrane layer thus acts as an indicator in these circumstances. This arrangement enables undesired electrical interferences to be minimised, such as capacitive charging currents or interferences from electroactive species that easily diffuse across the membrane.

In accordance with a further form of the present invention there is provided a sensing device for the determination of ions in a thin layer sample comprising:
a first and second ion selective electrode, each having a first and second layer;
the first layer of the first ion selective electrode being a polymeric membrane layer in electrical contact with the second layer of the first ion selective electrode, and the first layer of the second ion selective electrode being a polymeric membrane layer in electrical contact with the second layer of the second ion selective electrode;
the first and second ion selective electrodes being positioned in opposing arrangement such that, the respective polymeric membrane layers are in direct contact with a thin layer sample containing ions, located between the first and second electrodes; and
a detector in electrical connection with the first and second electrodes;

wherein the sensing device is an all solid state device.

In accordance with a still further form of the present invention there is provided a coulometric sensing device for the determination of ions in a thin layer sample comprising:
a first and second ion selective electrode, each having a first and second layer;
the first layer of the first ion selective electrode being a polymeric membrane layer in electrical contact with the second layer of the first ion selective electrode, and the first layer of the second ion selective electrode being a polymeric membrane layer in electrical contact with the second layer of the second ion selective electrode;
the first and second ion selective electrodes being positioned in opposing arrangement such that, the respective polymeric membrane layers are in direct contact with a thin layer sample containing ions, located between the first and second electrodes; and
a detector in electrical connection with the first and second electrodes.

In accordance with the present invention there is provided a method for the determination of ions in a thin layer sample comprising the method steps of:
contacting a thin layer sample containing ions to a first and second ion selective electrode each electrode having a first and second layer;
the first layer of the first ion selective electrode being a polymeric membrane layer in electrical contact with the second layer of the first ion selective electrode and the first layer of the second ion selective electrode being a polymeric membrane layer in electrical contact with the second layer of the second ion selective electrode;
applying a measuring potential to the first electrode allowing a current to flow across each electrode;
extracting ions out of the thin layer sample into the or each polymeric membrane layer where they are electrochemically coupled to an electron transfer reaction at the or each second layer; and
detecting the current decay via a detector in electrical contact with the first and second ion selective electrodes.

Preferably, the measuring potential is applied until about 50 to 99% of the analyte ions are extracted from the thin layer sample.

Preferably, the method comprises the additional step of applying a resting potential or zero current period. This has the benefit of allowing polymeric membrane layer to be regenerated substantially to its original state, in preparation for the next measurement. Optionally, this also may allow for back extracting the analyte ions into the thin layer sample once the measurement is complete. It may also be considered advantageous that this back-extraction step may return a thin layer sample substantially to its original composition, if desired.

The resting potential or zero current period is preferably applied for a time period which is longer than the original measurement time.

The correct measuring potential is preferably determined by conducting a voltage scan prior to performing a measurement.

### BRIEF DESCRIPTION OF THE DRAWINGS

The present invention will now be described, by way of example only, with reference to one embodiment thereof and the accompanying drawings, in which;

FIG. 1 is a diagrammatic representation of a sensing device according to a first embodiment of the present invention;

FIG. 2 is a diagrammatic representation of the chemical pathways which occur in use of the device of FIG. 1;

FIG. 3 is a design of a thin layer cell for an ion-extraction coulometric measurement conducted in a semi-solid state system, in accordance with a second embodiment of the present invention;

FIG. 4 shows a cyclic voltammogram obtained from a scan of the thin-layer cell of FIG. 3;

FIG. 5 is a scheme of the reactions occurring at the various peaks identified by the voltammogram in FIG. 3;

FIG. 6 depicts a typical coulometric measurement performed in the thin layer cell of FIG. 3;

FIG. 7 compares the normal pulse voltammetric responses of a device of the present invention as depicted in FIG. 3 and as an all solid state design;

FIG. 8 shows a cyclic voltammogram for an all solid state device as depicted in FIG. 1;

FIG. 9 shows the expected zero current Nernstian potentiometric response of a hollow fiber membrane doped with a calcium-selective membrane material to various concentrations of calcium in a background of 0.01 M potassium chloride;

FIG. 10 shows the depletion currents for the same hollow fiber membrane, containing a tightly fitting chlorinated silver wire and 50 μM of calcium chloride in 10 mM potassium chloride as sample solution inside of the tubing. Potentials are applied relative to the open circuit potential and result in the depletion of the inside sample solution;

FIG. 11 demonstrates for the same system that the decay currents are a direct function of the indicated calcium concentration. The inset shows the calculated charge from the same experiments and demonstrate linearity with concentration;

FIG. 12 shows normal pulse voltammetry on a 50 μm thin layer sample sandwiched between two ion-selective membranes, of which one contains a sodium-selective ionophore. One experiment contains the background electrolyte (10 mM lithium acetate) while the other contains 0.1 mM sodium perchlorate in the same background electrolyte;

FIG. 13 shows current decays in the coulometric operation of the same two thin layer sample solutions as in FIG. 12;

FIG. 14 demonstrates a Nernstian response slope for the potentiometric zero current behavior of a glass fiber membrane that was silanized and doped with an calcium-selective membrane material; and

FIG. 15 demonstrates a similarly Nernstian response slope for the potentiometric response of a silanized alumina membrane containing nanoscale pores and that is doped with a sodium-selective membrane material.

### BEST MODE(S) FOR CARRYING OUT THE INVENTION

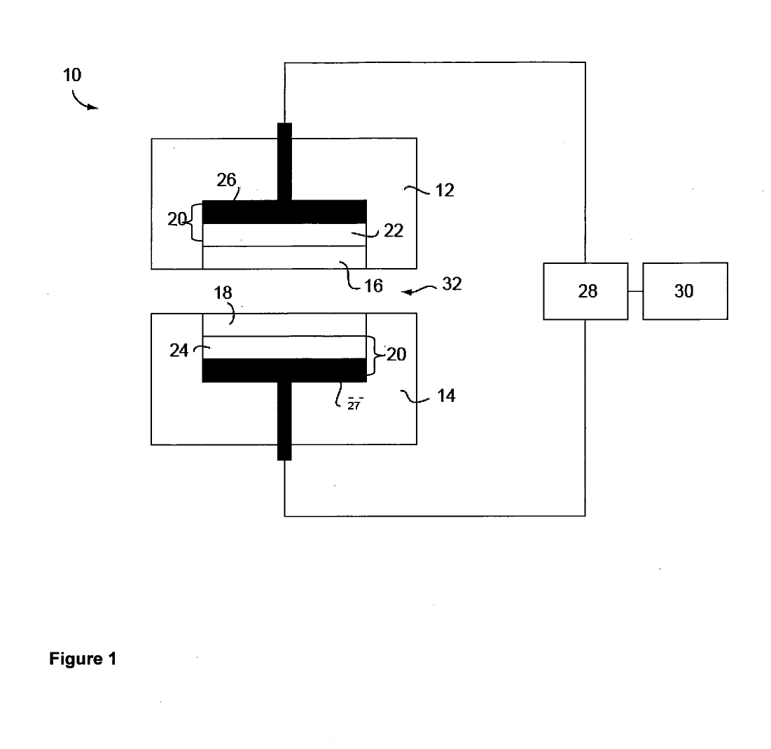

In FIG. 1 there is shown a sensing device 10 for the determination of ions in a thin layer sample, in accordance with a first embodiment of the present invention.

For the purpose of this description, the ions whose concentration are to be determined will be referred to as analyte ions.

A first and second solid state ion selective electrode, 12 and 14 each comprise a polymeric membrane layer 16 and 18, which is contacted with a second layer 20, by methods, including but not limited to, for example solvent casting, screen printing, spin coating or drop casting. The second layer 20 in turn comprises a transducer layer 22 and/or 24 and a conducting layer 26. This substantially eliminates the requirement for an inner aqueous electrolyte solution required in traditional electrodes in order to measure an electrical change. The transducer layers 22 and 24 facilitate the conversion of ions into an electrical current so that an oxidation reduction reaction can be measured. The transducer layers 22 and 24 are each formed from materials having functional groups that can be suitably oxidised or reduced while exhibiting hydrophobic properties including for example, ferrocene derivatives, conducting polymers, including poly(aniline), poly(pyrrole), poly(alkyl thiophene) with alkyl chains that are between 2 and 12 carbons long, and poly(alkyldioxythiophene) and poly(alkylmonoxythiophene) with alkyl chains lengths of 2 and 12 carbons.

The conducting layers 26 and 27 of each ion selective electrode 12 and 14, is in electrical connection with a potentiostat 28 and in turn, a detector 30, which monitors the decay of current as ions are extracted from the thin layer sample 32 into the polymeric membrane layers, 16 and 18. This measurement of current is integrated over time to calculate the number of coulombs in accordance Faraday's law. The number of coulombs can then be used to calculate the number of analyte ions extracted from the thin layer sample 32. The detector 30 is an electrical detector, for example, a coulometric detector to measure the depletion in current as a result of the analyte ion undergoing an oxidation/reduction reaction.

The polymeric membrane layer 16 or 18 and the transducer layer 22 and/or 24 ideally both have similar properties, for example electrochemical reversibility, compatibility and similar potential “windows”, which helps to avoid undesirable oxidation/reduction reactions occurring with species other than the material of the transducer layer 22 or 24. There is also solvent compatibility between the tranducer layer 22 or 24 and the polymeric membrane layer 16 or 18, to substantially avoid delamination of the material and the formation of an undesirable intermediate water layer, which would result in variable contact resistance and diminishing electrochemical reversibility and stability.

The polymeric membrane layer 16 and 18 is hydrophobic, or water immiscible, and is formed from plasticised or non-plasticised polymers including, for example, including poly(vinyl chloride), poly(alkyl acrylate) with an alkyl chain length of 3 to 16, poly(alkyl methacrylate) with an alkyl chain length of 3 to 16, silicone rubbers, polyurethanes, or a combination or co-polymer thereof. The hydrophobic nature of the polymeric membrane layers 16 and 18 substantially avoids spontaneous uptake of electrolyte/thin layer sample solution, which would result in interference at the electrode and a difficulty in measuring the presence and/or concentration of analyte ions. It is understood that a hydrophobic membrane will only uptake ions as a result of a suitably imposed potential, resulting in a current that can be counted.

In a first mode of operation, the polymeric membrane layer 16 or 18 has limited ion exchange properties to reduce the spontaneous extraction of any ions to and from the membrane and thin layer sample 32. This helps to minimise spontaneous contamination of the thin layer sample 32 in contact with the polymeric membrane layer 16 or 18. To maintain electroneutrality in the polymeric membrane layer 16 or 18, extraction of an analyte ion from the thin layer sample 32 into the polymeric membrane layer 16 or 18, is accompanied by the transfer of an ion from the transducer layer 22 or 24 (i.e. not the thin layer sample 32). In this mode of operation, the polymeric membrane layer 16 or 18 contains a suitable lipophilic electrolyte, for example, salts of long chain quaternary ammonium ions and tetraphenylborate derivatives, or sulfonated organic ions.

Alternatively, as a second mode of operation, the polymeric membrane layer 16 or 18 may comprise ion exchange properties. For example the polymeric membrane layer 16 or 18 may contain an ion exchange electrolyte, to effect transfer of analyte ions into the polymeric membrane layers 16 and 18. This allows one to monitor the open circuit potential and apply potentials relative to this measured value. This mode also allows for the use of membranes that are thin for example, less than 10 μm, and fast diffusing, since an applied voltage effects the transport of the same ion from the thin layer sample 32 across the polymeric membrane layer 16 or 18 and into the transducer layer 22 or 24. The polymeric membrane layer 16 or 18 is preferably in the form of a thin-layer membrane, with dimensions between about 10 nm to 10 μm, in order to facilitate the rapid and reversible ionic extraction in and out of the polymeric membrane layer 16 or 18.

Alternatively, the polymeric membrane layer 16 or 18 may be in the form of a thicker membrane layer, with dimensions between about 10 μm to 10 mm. In this arrangement the polymeric membrane layer 16 or 18 may act as a large electrolyte reservoir and operate in a detection mode where regeneration of the polymeric membrane layer 16 or 18 at the sample side is not critical. Further, this configuration may also involve the selective ionophores being retained by the second layer 20, such as by covalent attachment. The second layer 20 in this configuration is in the form of a thin layer with a thickness within the range of about 100 nm to 10 μm. The conducting layer 26 can be formed from any conducting metal, for example gold.

The polymeric membrane layers 16 and 18 are each doped with a suitable ionophore, which is selective to the ion to be extracted, for example, the ionophore contains suitable functional groups for complexing ionic species and a lipophilic backbone to retain the molecule in the polymeric membrane layers 16 or 18. The ionophore may be covalently attached onto the polymeric backbone of the polymeric membrane layer 16 or 18 itself. Alternatively, the ionophores may be attached to a solid membrane support layer 17, which imparts strength to the polymeric membrane layers 16 and 18 whilst maintaining good mobility, for example, a diffusion coefficient within the range of approximately 10⁻⁶ to 10⁻⁸ cm²s⁻¹, for example 10⁻⁶ to 10⁻⁷ cm²s⁻¹, unlike standard stiffened polymers which exhibit a reduction in mobility, for example, a diffusion coeffeicient of approximately 10⁻⁸ cm²s⁻¹ or less. The solid membrane support layer 17 may be formed from a number of materials known in the art including, for example, silica, metal alloy or oxide such as porous alumina, ceramic, glass or glass fiber materials including filters, carbon, titania, carbide, nitride or sintered metal. The solid support layer is suitably coated, for example by silanization, to be coated or doped with the ion-selective membrane material.

Ionophores are required for most analytes in order to impart selectivity to the polymeric membrane 16 and/or 18. However, there are some analytes which do not require selective ionophores, for example some hydrophobic ions including perchlorate, nitrate, cesium, barium and various organic ions.

The solid state ion selective electrodes 12 and 14 are arranged such that the polymeric membrane layers 16 and 18 are in opposing arrangement with respect to each other. In use, a thin layer sample 32, having a known volume, is located therebetween so that the thin layer sample 32 is able to simultaneously contact the polymeric membrane layers 16 and 18 of both ion selective electrodes 12 and 14. The distance between the two electrodes 12 and 14 and therefore, the polymeric membrane layers 16 and 18, is within the range of about 10 to 200 μm. The area between the electrodes is known so that the volume of the thin layer sample 32 can be easily determined, and therefore the concentration of the analyte ion from the observed coulomb number. It is understood that if the distance between the electrodes 12 and 14 is too short, then the analysis time will also be too short relative to the capacitive charging current pulse upon applying the excitation potential. If the distance is too long then excessively long analysis times will be required.

Prior to performing a measurement a voltage scan may be conducted to determine an appropriate measuring potential to be applied. This will be particularly important where the analyte to be detected varies. If necessary, the cell resistance may also be evaluated by applying a rapid oscillating potential pulse prior to analysis, allowing one to correct for variable potential drops that originate from this resistance.

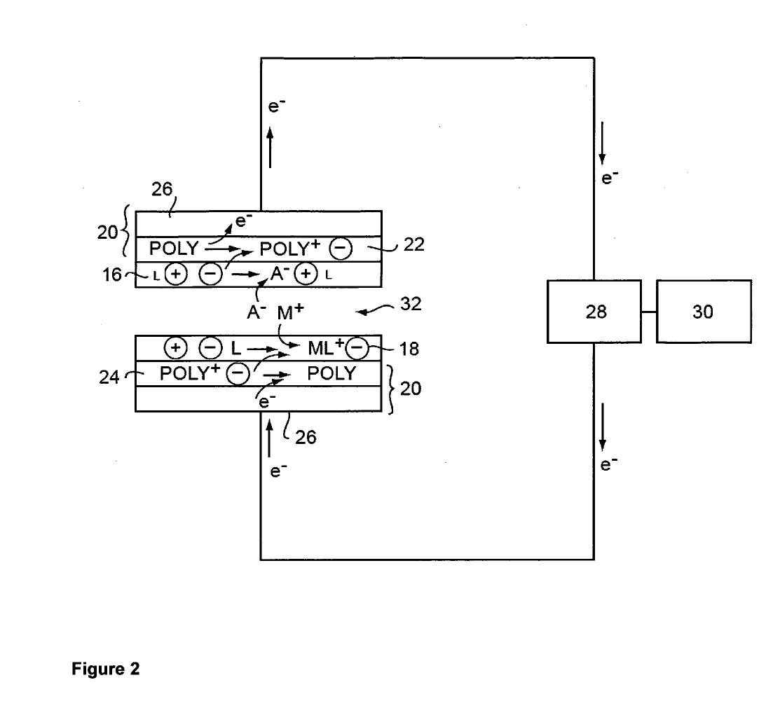

During a measurement the potentiostat 28 applies the measuring potential to the first ion selective electrode 12. This results in migration of analyte ions, depicted in FIG. 2 as A⁻, from a thin layer sample 32, into the polymeric membrane layer 16, where it interacts with a ionophore L and in turn results in the transfer of an intermediate ion to the transducer layer 22. The electrons flow via the conductor layer 26 through the circuit to the conductor layer 27 of the second ion selective electrode 18. At the second ion selective electrode, a reverse reaction occurs whereby electrons flow from the conductor 27 to the tranducer layer 24. This causes migration of an intermediate ion into the polymeric membrane layer 18 causing oppositely charged ions (depicted as M⁺) to be extracted from the thin layer sample 32.

The flow of electrons is an electrical current which can be detected by the coulometric detector 30. As the reaction proceeds and the concentration of analyte ions in the thin layer sample 32 are depleted, a decay in the electrical current is observed until it becomes so minimal as to approach zero. At this point substantially all of the analyte ions have been extracted from the thin layer sample 32. By integrating the current measured by the detector 30, the concentration of the analyte in the thin layer sample 32 can be determined.

The measuring potential is applied for a time sufficient to extract at least about 50 to 99% of the analyte ions from the thin layer sample 32 into the polymeric membrane layer 16. This will be dependent on the geometry, selectivity and chemistry of the polymeric membrane layer 16 or 18, with films of less than 1 to 5 μm thickness requiring much shorter regeneration times. It is anticipated that optimal geometries may allow one to extrapolate from an initially recorded current decay to infinite time by use of suitable diffusion models, thus simplifying the experimental procedure and enabling shorter analysis times.

Once a measurement is complete, a resting potential or zero current period is then applied to effect regeneration of the polymeric membrane layer 16 or 18 substantially to its original state. The application of a resting potential or zero current period may also effect the reversal of the reaction and subsequently deposit most of the extracted analyte ions back into the thin layer sample 32. This is particularly advantageous for situations where it is not desired or safe to substantially alter the thin layer sample 32 composition in the course of the measurement, such as in clinical or biochemical monitoring scenarios. The resting potential or current is applied for a longer time period than the measuring potential, to ensure substantially all of the analyte ions are back-extracted. The time period will be dependent on the polymer membrane geometry, composition and mode of operation.

In a second preferred embodiment, the second layer 20 is formed of an aqueous or gelified inner solution in contact with a reference electrode to complete an electrochemical cell. Preferably, the second layer 20 comprises a silver/silver chloride couple.

The polymeric membrane layer 16 or 18 prevents direct contact of the solid sensing layer 20 with the thin layer sample 32, thus avoiding interferences caused by fouling at the electrode surface. Interferences are also substantially avoided because only the ions selectively extracted into polymeric membrane layer 16 or 18 result in a oxidation/reduction reaction at the ion to electron transduer layer 22 or 24 in contact with the electron conductor. The polymeric membrane layer 16 or 18 is itself selective to the analyte ion and therefore does not require an enzyme reaction to impart selectivity to the electrode.

It is envisaged that the polymeric membrane layer 16 or 18 can be coated with a hydrophilic layer to aid in biocompatibility and infer a charge transfer resistance to regulate the ion transfer kinetics from the thin layer sample to the membrane phase. Such hydrophilic layers may include, but are not limited to, cellulose materials, hydrogels, surfactants, covalently attached molecules containing hydrophilic or electrically charged functional groups, and polyelectrolyte multilayers.

The transducer layers 22 and 24 may also be doped with a ionic species common to the polymeric membrane layer 16 or 18, for example a tetraphenylborate derivative. This doping process may also occur spontaneously during a suitable conditioning process with an aqueous thin layer sample before first use.

It is envisaged that the transducer layers 22 and 24 can be spin coated or electro-polymerised onto a conducting layer 26.

It is also envisaged that other types of detectors can be used, for example, optical detectors. Where the detector is an optical detector, it detects a change in colour in the polymeric membrane layer, which results from a reaction of the analyte ion with a ionophore in the polymeric membrane layer 16 or 18. The polymeric membrane layer 16 or 18 thus acts as an indicator in these circumstances. This arrangement enables undesired electrical interferences to be minimised, such as capacitive charging currents or interferences from electroactive species that easily diffuse across the membrane, for example, oxygen. An optical readout may be performed on a smaller area than the active electrode surface, helping to eliminate errors arising from diffusion of analyte from the surrounding solution.

It is understood that the active electrode area and cell design needs to be optimal to reduce the effect of mass transport of analyte from the surrounding solution into the thin layer where the detection (coulometric or optical) is performed. This may be accomplished by judicious choice of active surface area and geometry relative to the areas that contact the remainder of the sample. Small electrode areas may be accomplished by using a bipotentiostat configuration utilizing an outer and inner electrode held at the same potential, and recording the current for coulometry only at the inner electrode. Any undesired mass transport processes from the contacting solution will have an effect on the outer electrode only, thereby allowing one to work with smaller dimensions at high accuracy.

One of the primary benefits of utilising controlled potential coulometric detection for determining the concentration of an analyte is that no calibration is required. This is because substantially all of the analyte ions are extracted from the thin layer sample and measured. In addition, having an all solid state system means that a practical device can be developed for a wide range of applications, for example environmental monitoring and clinical diagnostics (in-vivo or in-vitro).

The all solid state system further enables the device to be miniaturised to a much greater degree than present technologies in the field of coulometry. The solid state electrode/s coupled with ion extraction enables detection of species that cannot be electrolysed at an electrode using traditional techniques such as voltammetry. That is, any ion for which a selective membrane can be fabricated can be detected, including but not limited to, calcium, potassium, sodium, lithium, magnesium, ammonium, nitrate, perchlorate, chloride, salicylate, iodide, carbonate, bicarbonate, anticoagulant heparin via protamine titration, total acidity, total basicity.

Enzymes may also be utilised to determine metabolites and/or organics. For example, by coupling urease with urea, ammonium is produced. Ammonium, in turn, can be detected coulometrically.

The present invention is further illustrated by way of the following non-limiting examples:

### Example 1

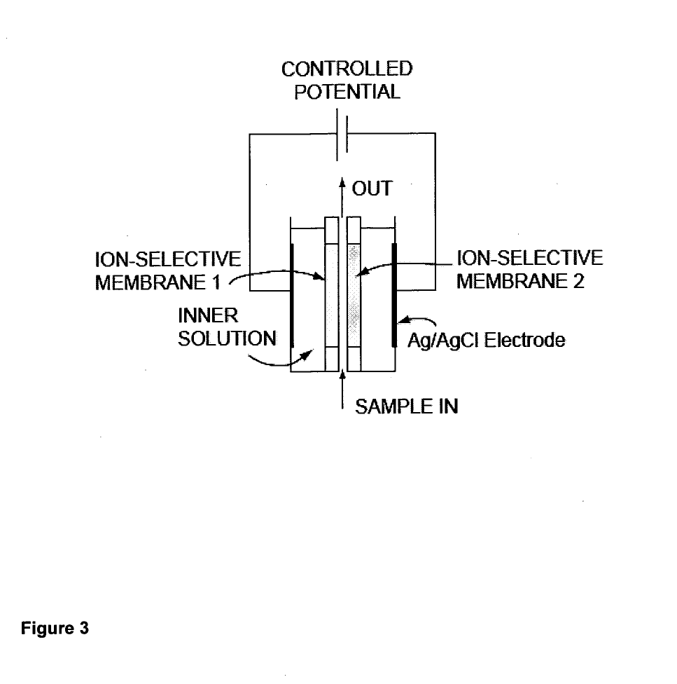

In FIG. 3 there is depicted an experimental set-up for measurement of an analyte ion according to a second embodiment the present invention, involving polymeric membranes having an inner aqueous electrolyte. Two polymeric membrane electrodes are spaced closely together and are each contacted with an aqueous inner solution, as depicted in FIG. 3. The cell is completed by placing a silver/silver chloride electrode into each of the inner solutions. The spacing between the two membrane electrodes contains the thin layer sample solution. Accurate spacing is preferably accomplished by a hard spacing material. The polymeric membranes preferably have a well defined and constant shape, but preferably retain a high ion mobility. This is preferably accomplished by containing the membrane within a hard porous material such as a ceramic or crosslinked polymer.

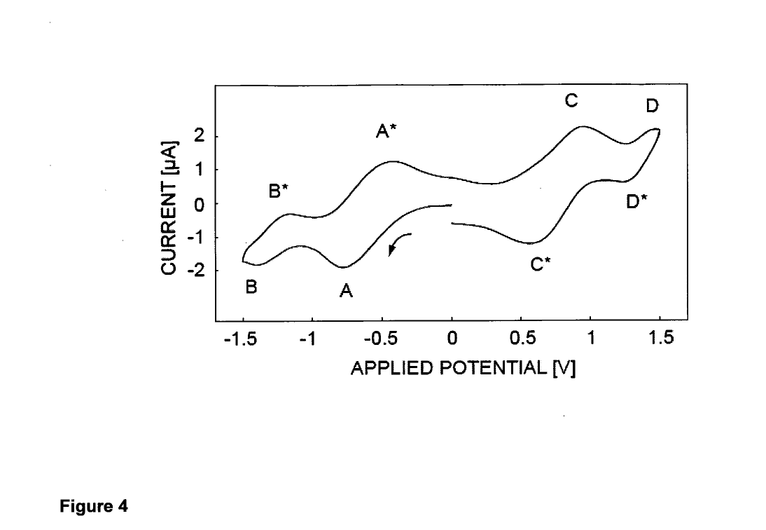

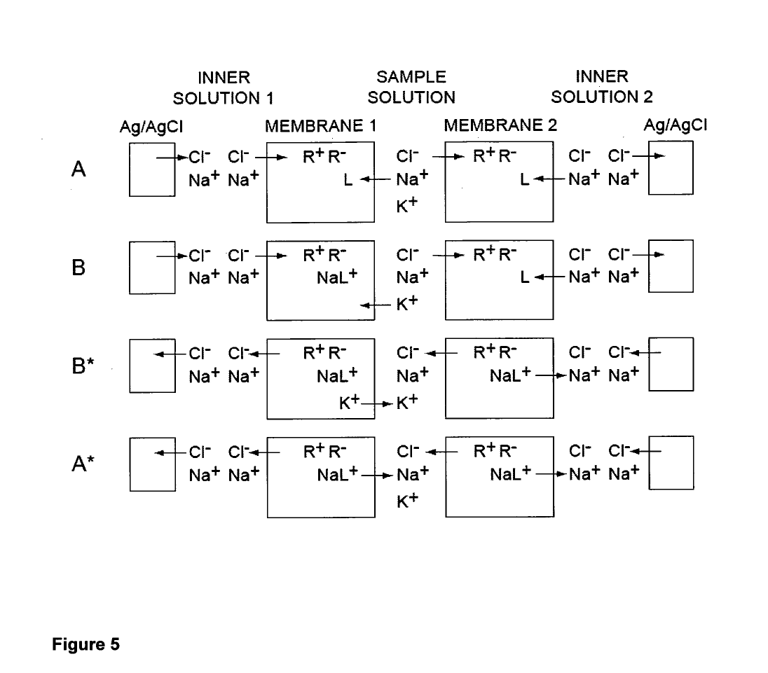

FIG. 4 shows a cyclic voltamogram obtained from a scan of the thin-layer cell of FIG. 3. The polymeric membrane layer was produced by solvent casting and contains poly(vinyl chloride) plasticized with bis(2-ethyl hexyl sebacate) in a mass ratio of 1:2. The polymeric membrane layer was formulated to also contain a lipophilic electrolyte, 10 wt % of tridodecylmethylammonium tetrakis(4-chlorophenylborate) and 10 mM of the sodium-selective ionophore tert-butylcalix[4]arene tetraethyl ester. The inner solutions contained both 10 mM NaCl, while the thin layer sample contained 1 mM NaCl and 10 mM KCl. FIG. 4 shows the observed current of a thin layer electrode configuration as an applied potential is cycled in the window between −1.5 V and 1.5 V, with a starting and ending potential of zero volts. Note the direction of the scan by the indicated arrow. A total of 8 peaks are noted, which are approximately symmetrical owing to the symmetric geometry and composition of the cell. As the potential is scanned from 0 to −1.5 V, peaks A and B appear. FIG. 5 interprets these regions with the indicated reactions. At peak A, the desired extraction of sodium into membrane 1 and of chloride into membrane 2 is accomplished selectively, without interference from potassium. At peak B, the applied potential is sufficiently large to also effect the extraction of potassium. At B*, potassium ions are back extracted from membrane 1 into the thin layer sample. At A*, the back extraction of sodium ion is observed. Note that peaks C and D at positive potentials are essentially the same processes as for A and B, but with reversed polarity.

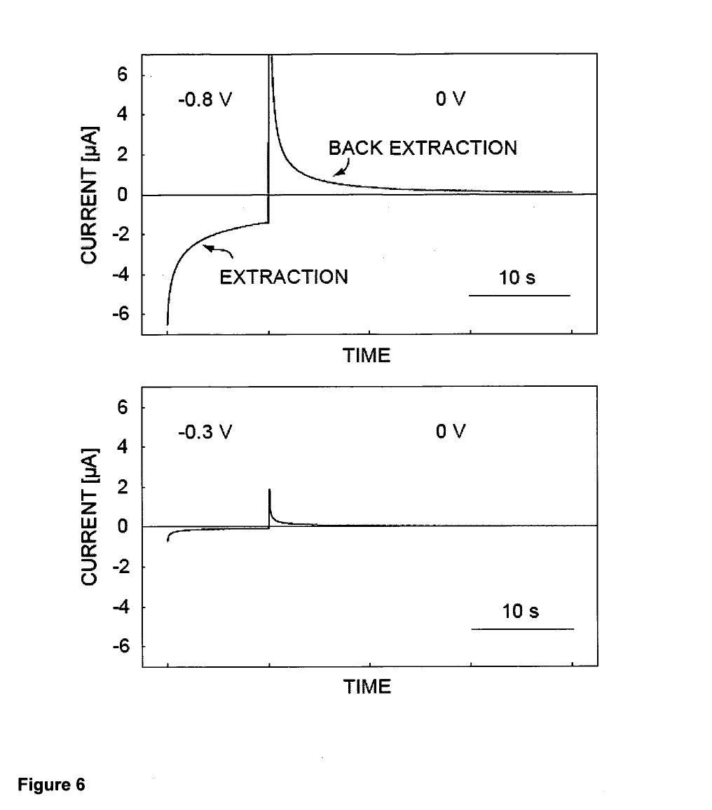

A typical coulometry experiment is demonstrated in FIG. 6, where the potential is stepped from zero to −0.8 V and held at that value for a period of time, in this case 20 s. Note that this corresponds to peak A in FIG. 1. A current is observed that decays with time, signifying the exhaustive extraction of sodium into membrane 1. The integrated Faradaic current during this pulse yields the total charge for the extraction process, and translates into the amount of material in the thin layer sample by using Faraday's law. Smaller membrane spacings will give rise to a faster decay. As the potential is stepped back to zero volts, the current spike changes sign and again decays with time, demonstrating the back extraction from the membrane into the thin layer sample. FIG. 2 also shows the observed current as the potential is stepped to just −0.3 V, with is approximately at the beginning of the sodium extraction region. The potential is not sufficiently large to effect a sodium extraction process. Note that the back extraction current at 0 V is also very small. This shows how the magnitude of the applied potential is an effective parameter to optimize the working conditions of the coulometric sensor.

### Example 2

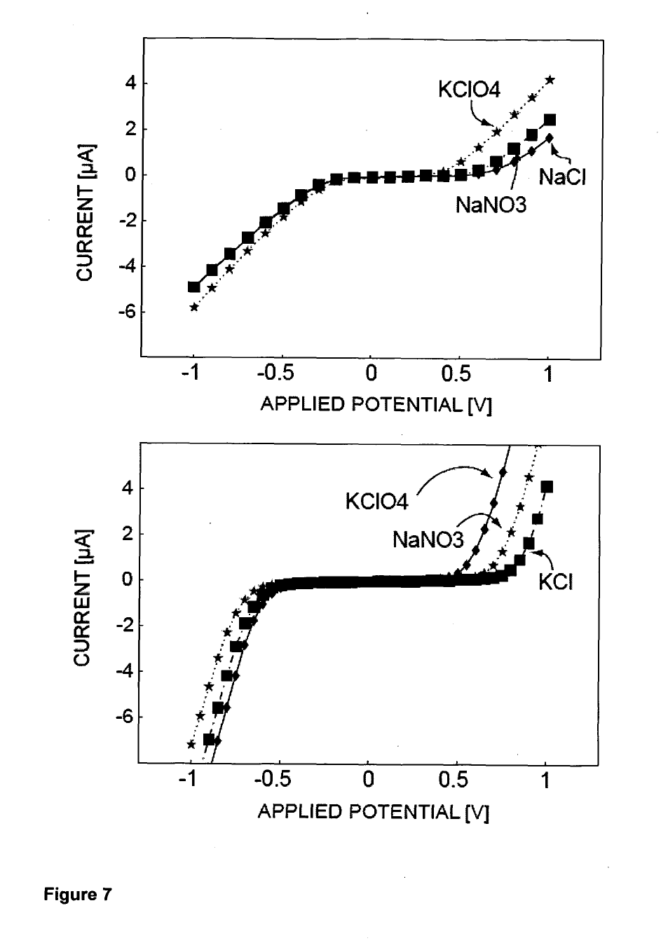

A different example entails the development of ion selective electrodes exhibiting a conducting polymer cast onto a solid support as an all-solid state design. FIG. 7 compares the normal pulse voltammetric responses of two ion-selective electrodes to the indicated electrolytes (each at 1 mM concentrations). The top plot shows the behavior of a membrane containing an aqueous inner contact, measured against a traditional reference electrode. The membrane did not contain an ionophore for simplicity reasons, but otherwise is comparable to the composition given in Example 1. Normal pulse voltammetry subjects the cell to an extended baseline potential pulse (here at 0 V) between excitations. This gives voltammetric responses that only reflect ion uptake processes and are simpler to interpret. At positive potentials, the currents start to increase, which is indicative of anions entering the membrane from the thin layer sample solution side. The preference for this process is perchlorate > nitrate > chloride, which reflects the order of hydrophilicity for these ions. This is also called the Hofineister selectivity sequence. At negative potentials, the cations potassium and sodium are extracted, again in the order of potassium > sodium.

For the bottom plot, a gold electrode was coated with poly(ethylenedioxythiophene), PEDOT, doped with polystyrene sulfonate (PSS) by solvent casting. The ion-selective membrane, containing the same composition as for the top plot, was solvent cast on top of the conducting polymer and resulted in an all-solid state electrode. The bottom plot of FIG. 7 shows the same basic behaviour for electrolyte extraction as for the aqueous inner solution system, demonstrating the feasibility of designing all solid state electrodes for coulometric measurements.

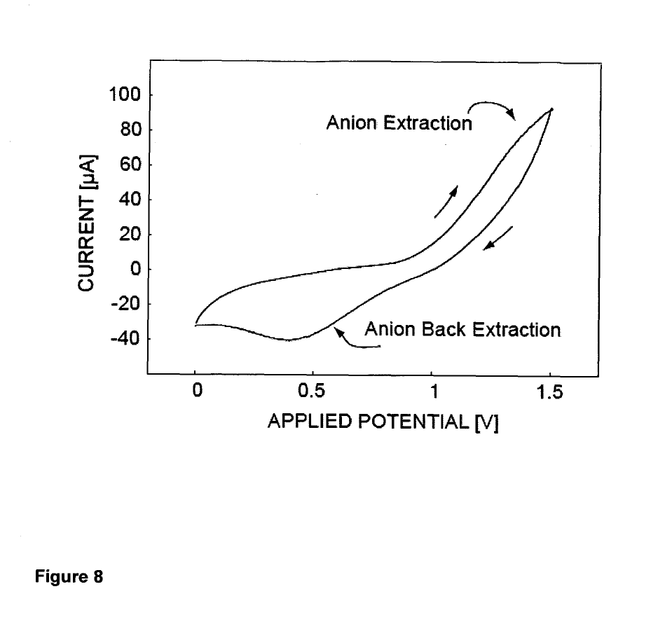

FIG. 8 shows the cyclic voltammogram for an all solid state membrane containing poly(octylthiophene) as conducting polymer and coated with a plasticized PVC membrane without ionophore. The conducting polymer was obtained by electropolymerization onto indium tin oxide (ITO) glass. The overlay membrane was spin coated and contained a lipophilic salt of the tetradodecylammonium cation and the tetrakis[3,5-bis(trifluoromethyl)phenyl]borate. FIG. 8 demonstrates the cyclic voltammogram for chloride anion uptake from the thin layer sample solution into the all solid state membrane assembly, which occurs above 1 V. Scanning the potential back toward 0 V reveals that the chloride anions are extracted back out of the film around 0.4 V. This demonstrates that all solid state membrane electrodes with electropolymerized and lipophilic conducting polymers as underlayers can be successfully fabricated.

### Example 3

A third example employs a membrane material doped into a porous polypropylene tubing material (600 μm inner diameter), whose inside compartment contains a chlorinated silver wire of 500 μm diameter. The impregnated tubing is connected on one side to a pump or other sample delivery system, while the other side is connected to waste while the silver wire acts as the working electrode and is connected to a potentiostat. The impregnated tubing is wholly immersed in an aqueous electrolyte solution where the counter and reference electrodes are placed.

In the specific example, the tubing is impregnated with the lipophilic solvent dodecyl 2-nitrophenyl ether, 10 wt % of lipophilic electrolyte tridodecylmethylammonium tetrakis(4-chlorophenylborate), 10 mmol/kg membrane of the Ca²⁺-ionophore N,N,N′,N′-tetradodecyl-3,6-dioxaoctanedithioamide and 30 mol % (relative to the ionophore) of potassium tetrakis[3,5-bis(trifluoromethyl)phenyl]borate. The sample solutions consisted of 0.01 M KCl plus the indicated concentration of calcium, while the solution outside of the tubing consisted of 10⁻³ M CaCl₂ in 10⁻² M KCl. A platinum electrode served as the counter electrode, while a double junction reference electrode was used.

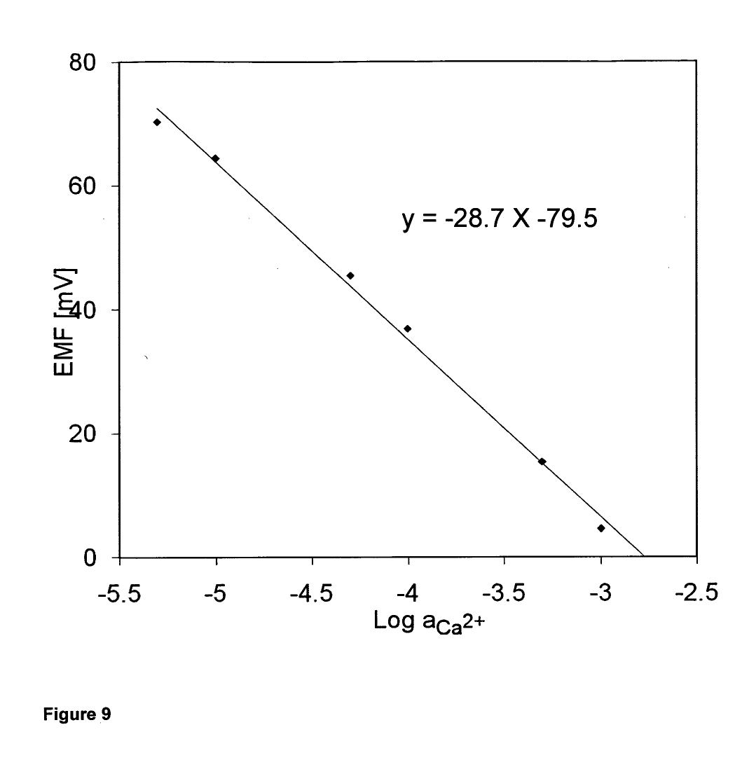

In this example, the inside of the tubing acts as the thin layer sample solution. Importantly, this configuration can be electrochemically monitored under zero current conditions without substantially perturbing the composition of this thin layer sample solution. FIG. 9 demonstrates that such a configuration gives a Nernstian response to logarithmic calcium concentration in complete analogy to a traditional calcium-selective electrode.

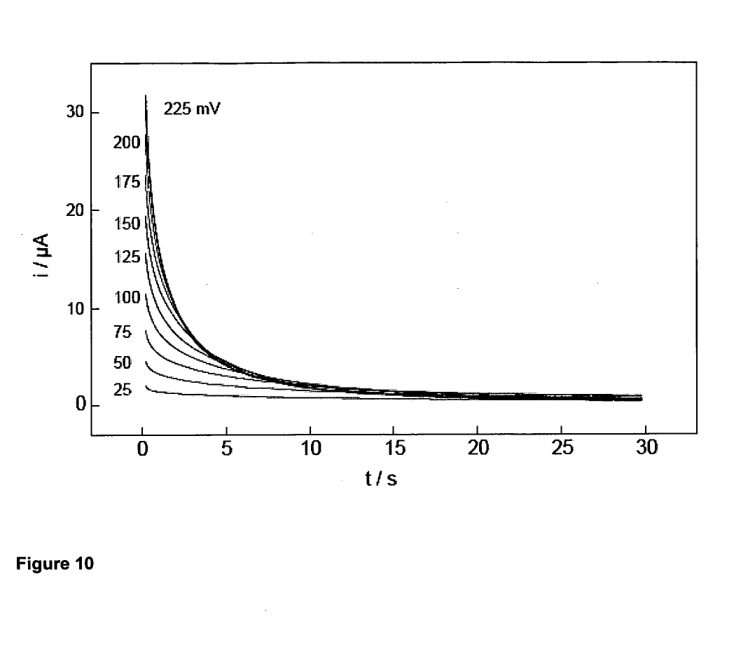

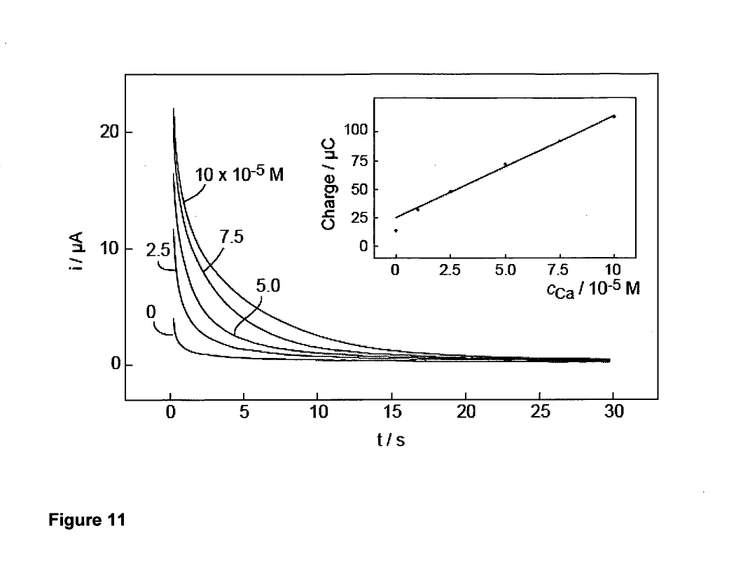

Monitoring the zero current potential allows one to apply a potential that is larger by a set quantity relative to the open circuit potential, without requiring a knowledge of the involved concentrations. This results in the transport of calcium from the thin layer sample solution into the membrane and outside bathing solution, which is monitored as a depletion current. FIG. 10 shows for the 50 μM calcium in the thin layer sample, depletion currents increase with applied potential until they become indifferent of applied potential. FIG. 11 illustrates for an applied potential of 270 mV that the observed current decays are a direct function of calcium concentration. The inset shows the calculated charge (integrated from the current decays) as a function of concentration, demonstrating linearity with concentration.

In this measurement configuration, knowledge of the thin layer sample solution or outside bathing solution is not necessary for proper functioning of the device. In fact, the device can operate with inner and outside solutions of the same, unknown composition.

Note that the hollow fiber membrane configuration is especially attractive when coupled to a transmembrane accumulation process. In this scenario, the thin layer sample solution is placed outside the tubing, while the inner solution contains a specific composition that results in the transport and accumulation of the analyte ions from the thin layer sample into the inner compartment. When this process approaches equilibrium, the readout of the inner compartment is accomplished as described above.

### Example 4

The fourth example demonstrates the thin layer coulometric behavior in analogy to Example 1, but with a custom made flow through cell in which the thin layer sample is guided through a meandering channel that is sandwiched between two ion-selective membranes. In this example, the channel is designed to be 50 μm deep and 1 mm wide. Depth and width can vary. Both ion-selective membranes consist of 10 wt % of lipophilic electrolyte tridodecylmethylammonium tetrakis(4-chlorophenylborate), and poly(vinyl chloride) and the plasticizer bis(2-ethyl hexyl sebacate) in a 1:2 ratio by mass, while one of the two membranes additionally contains 10 mmol of the sodium-selective ionophore tert-butylcalix[4]arene tetraethyl ester per kilogram of membrane. The membranes are about 100 μm thick, and are each contacted with a 0.1 M aqueous lithium acetate solution in which a chlorinated silver electrode is immersed.

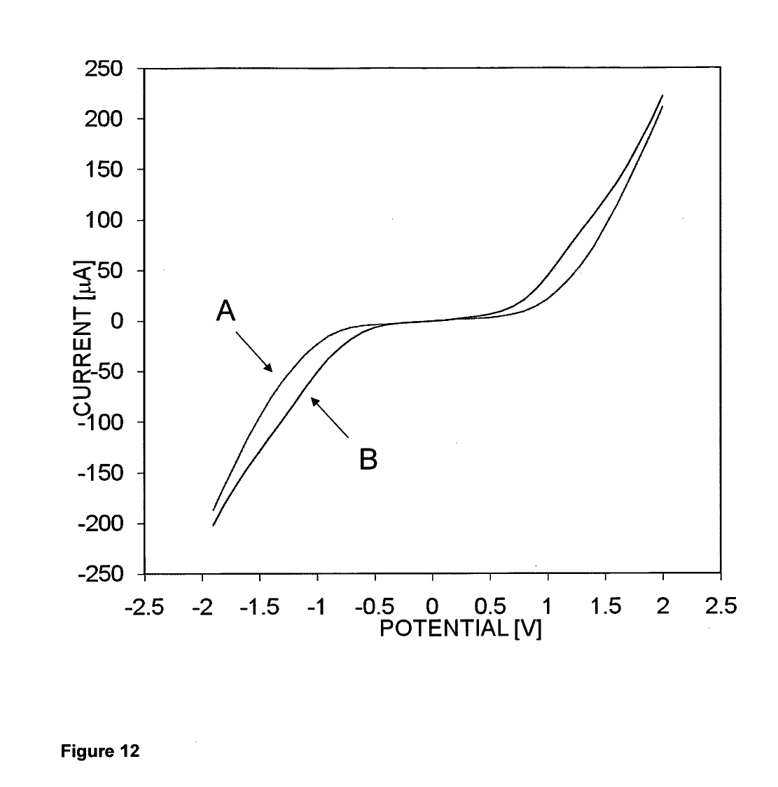

FIG. 12 shows normal pulse voltammetric response of this cell, containing either 0.01 M lithium acetate (A) or 10⁴ M sodium perchlorate in the same 0.01 M lithium acetate background (B). The current readings were taken after 1 s of applied potential for each of the indicated values, while a resting potential of 0 V was applied between pulses. The figure demonstrates that the sensor system can be operated at positive or negative potential values. At negative potentials, there is a somewhat larger separation from the background because of the presence of the sodium ionophore in the membrane side where cation extraction from the thin layer sample occurs.

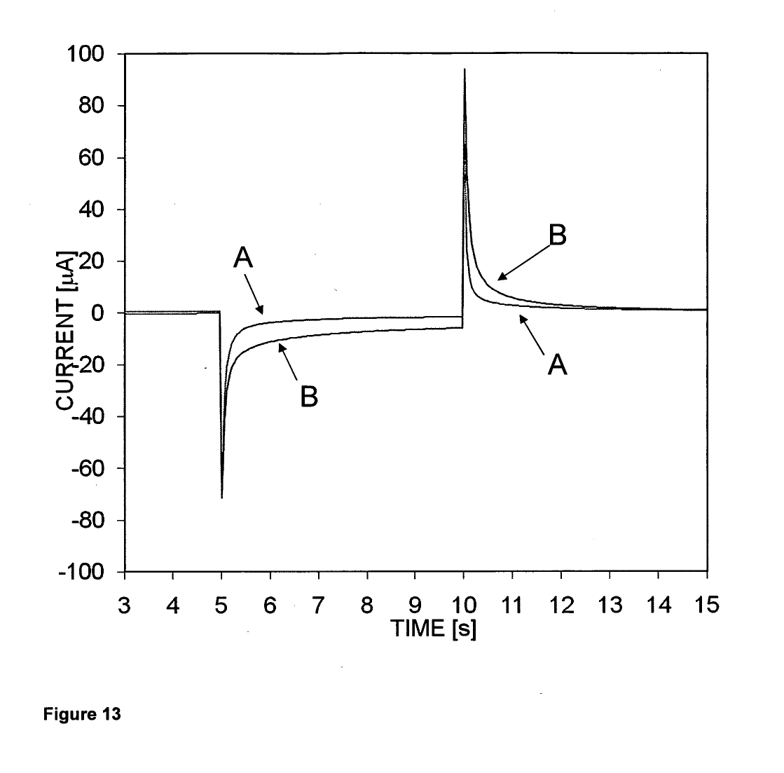

FIG. 13 shows the current decay upon an applied negative potential pulse (same setup as in FIG. 12 for either the background alone or the background plus 10⁻⁴ M sodium perchlorate, demonstrating the coulometric response principle for a thin layer sample sandwiched between two polymeric membranes.

### Example 5

This fifth example demonstrates the use of a rigid support for the fabrication of ion-selective polymeric membranes. One example of such a support has already been shown above under example 3 with a porous polypropylene material.

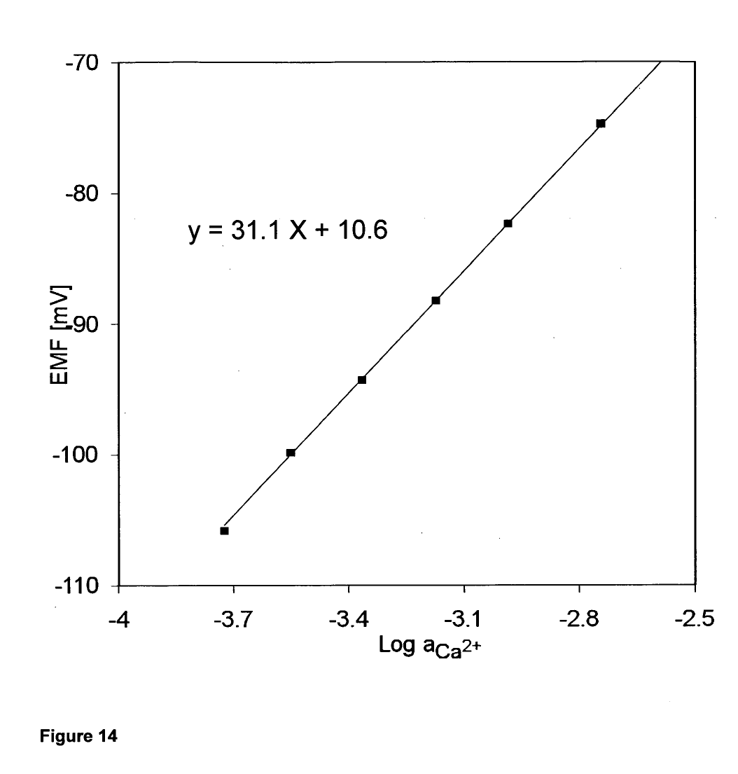

In FIG. 14 the potentiometric response at zero current is demonstrated for a silanized glass fiber filter containing a membrane of the following composition: 10 wt % of lipophilic electrolyte tridodecylmethylammonium tetrakis(4-chlorophenylborate), 10 mmol/kg of membrane of the Ca²⁺-ionophore N,N,N′,N′-tetradodecyl-3,6-dioxaoctanedithioamide and 30 mol % (relative to the ionophore) of the ion-exchanger potassium tetrakis[3,5-bis(trifluoromethyl)phenyl]borate in poly(vinyl chloride) and bis(2-ethyl hexyl sebacate) (mass ratio 1:4). The membrane material is solvent cast into the filter after silanization. The potentiometric calcium response is rapid and follows theoretical expectations, suggesting that such a glass fiber filter is a promising material for a solid membrane support.

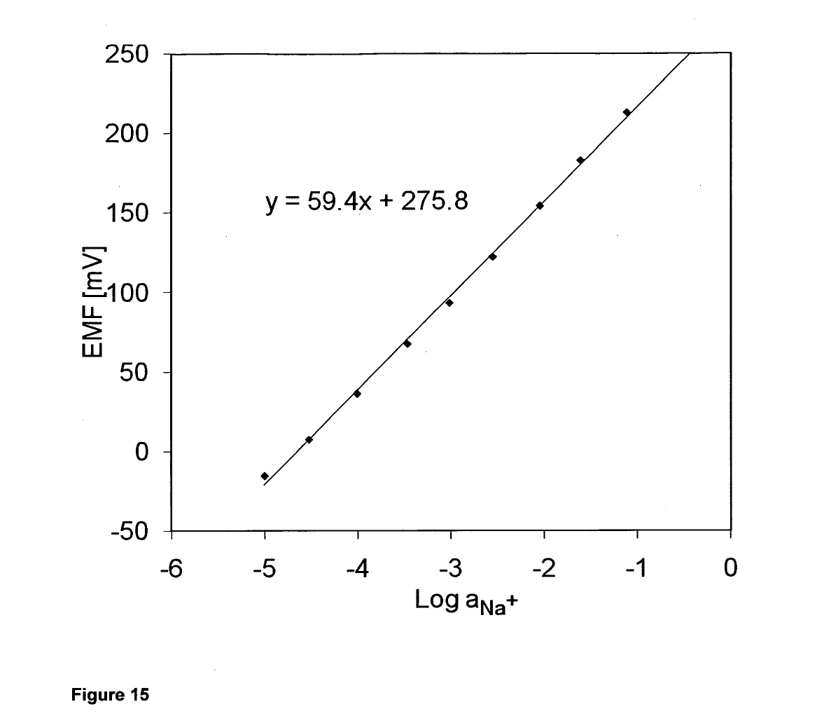

A similar result is shown in FIG. 15 for a 20 μm thin nanoporous alumina membrane (Anodisk), made hydrophobic by silanization and subsequently doped with the following sodium-selective material: 10 wt % of lipophilic electrolyte tridodecylmethylammonium tetrakis(4-chlorophenylborate), 10 mmol per kg of membrane of the sodium-ionophore tert-butylcalix[4]arene tetraethyl ester and 50 mol % (relative to the ionophore) of the ion-exchanger potassium tetrakis[3,5-bis(trifluoromethyl)phenyl]borate in poly(vinyl chloride) and bis(2-ethyl hexyl sebacate) (at a mass ratio of 1:2). The expected Nernstian response slope for sodium is observed in a wide linear range, suggesting that such nanoporous membranes are suitable supports for ion-selective electrodes.

Modifications and variations such as would be apparent to the skilled addressee are considered to fall within the scope of the present invention.

1. A sensing device for the determination of ions in a thin layer sample comprising:
a first and second ion selective electrode, each having a first and second layer;
the first layer of the first ion selective electrode being a polymeric membrane layer in electrical contact with the second layer of the first ion selective electrode, and the first layer of the second ion selective electrode being a polymeric membrane layer in electrical contact with the second layer of the second ion selective electrode;
the first and second ion selective electrodes being positioned in opposing arrangement such that, the respective polymeric membrane layers are in direct contact with a thin layer sample containing ions, located between the first and second electrodes; and
a detector in electrical connection with the first and second electrodes.

2. A sensing device according to claim 1, wherein the thin layer sample is not in direct contact with the second layer of the first or second ion selective electrode.

3. A sensing device according to claim 1, wherein the polymeric membrane layer is selective to the analyte ions.

4. A sensing device according to claim 1, wherein the second layer is formed of an aqueous inner solution in contact with a reference electrode.

5. (canceled)

6. (canceled)

7. A sensing device according to claim 1, wherein the second layer comprises a solid transducer layer and a solid conducting layer.

8. A sensing device according to claim 7, wherein the transducer layer is formed from materials containing chemically bound functionalities capable of being oxidised or reduced.

9. A sensing device according to claim 7, wherein the transducer layer is hydrophobic.

10. A sensing device according to claim 7, wherein the transducer layer is formed from materials including, but not limited to, ferrocene derivatives.

11. A sensing device according to claim 7, wherein the transducer layer is formed from materials including, but not limited to conducting polymers, including poly(aniline), poly(pyrrole), poly(alkyl thiophene) with alkyl chains that are between 2 and 12 carbons long, and poly(alkyldioxythiophene) and poly(alkylmonoxythiophene) with alkyl chains lengths of 2 and 12 carbons.

12. A sensing device according to claim 7, wherein the transducer layer is doped with an ionic species common to the polymeric membrane layer.

13.-17. (canceled)

18. A sensing device according to claim 1, wherein the polymeric membrane layer exhibits ion exchange properties.

19. (canceled)

20. A sensing device according to claim 1, wherein the polymeric membrane layer contains a lipophilic electrolyte.

21. A sensing device according to claim 20, wherein the lipophilic electrolyte comprises salts of long chain quaternary ammonium ions and tetraphenylborate derivatives or sulfonated organic ions.

22. A sensing device according to claim 1, wherein the polymeric membrane layer is doped with ionophores.

23. (canceled)

24. A sensing device according to claim 22, wherein the ionophores are covalently attached to the polymeric membrane layer or a solid support layer.

25. (canceled)

26. A sensing device according to claim 24, wherein the solid support layer is formed from known materials including, silica, metal alloy or oxide, porous alumina, ceramic, glass or glass fibre materials such as filters, carbon, titania, carbide nitride, or sintered metal.

27. A sensing device according to claim 1, wherein the polymeric membrane layer is hydrophobic.

28. A sensing device claim 1, wherein the polymeric membrane layer is hydrophobic and coated with a hydrophilic layer.

29. A sensing device according to claim 1, wherein the polymeric membrane layer has a thickness that falls within the range of about 10 nm to 10 mm.

30.-35. (canceled)

36. A coulometric sensing device for the determination of ions in a thin layer sample comprising:
a first and second ion selective electrode, each having a first and second layer;
the first layer of the first ion selective electrode being a polymeric membrane layer in electrical contact with the second layer of the second ion selective electrode, and the first layer of the second ion selective electrode being a polymeric membrane layer in electrical contact with the second layer of the second ion selective electrode;
the first and second ion selective electrodes being positioned in opposing arrangement such that, the respective polymeric membrane layers are in direct contact with a thin layer sample containing ions, located between the first and second electrodes; and
a detector in electrical connection with the first and second electrodes.

37. A method for the determination of ions in a thin layer sample comprising the method steps of:
exposing a thin layer sample containing ions to a first and second ion selective electrode each electrode having a first and second layer;
the first layer of the first ion selective electrode being a polymeric membrane layer in electrical contact with the second layer of the first ion selective electrode and the first layer of the second ion selective electrode being a polymeric membrane layer in electrical contact with the second layer of the second ion selective electrode;
applying a measuring potential to the first electrode allowing a current to flow across each electrode;
extracting ions out of the thin layer sample into the or each polymeric membrane layer where they are electrochemically coupled to an electron transfer reaction at the or each second layer; and
detecting the current decay via a detector in electrical contact with the first and second ion selective electrodes.

38. A method according to claim 37, wherein the measuring potential is applied until about 50% to 99% of the analyte ions are extracted from the thin layer sample.

39. A method according to claim 37, wherein a resting potential or zero current period is applied after the step of detecting current decay.

40.-41. (canceled)
